(19) United States
(12) Patent Application Publication
(10) Pub. No.: US 2005/0289152 A1
(43) Pub. Date: Dec. 29, 2005

(54) Method and apparatus for implementing a file system

(76) Inventors: William J. Earl, Boulder Creek, CA (US); Chetan Rai, Palo Alto, CA (US); Kevin Sheehan, Palo Alto, CA (US); Patrick M. Stirling, Oakland, CA (US); Brian Byrnes, Mountain View, CA (US); Tomasz Barszczak, Fremont, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 10/866,229

(22) Filed: Jun. 10, 2004

(51) Int. Cl. G06F 17/00

(52) U.S. Cl. 707/100

(57) ABSTRACT

A system and method for efficiently implementing a local or distributed file system is disclosed. The system may include a distributed virtual file system (“dVFS”) that utilizes a persistent intent log (“PIL”) to record transactions to be applied to the file system. The PIL is preferably implemented in stable storage, so that a logical operation may be considered complete as soon as the log record has been made stable. This allows the dVFS to continue immediately, without waiting for the operation to be applied to a local or real file system. The dVFS may further incorporate replication to one or more remote file systems as an integral facility.

### FIELD OF THE INVENTION

The present invention relates generally to file systems, and more particularly to a method and apparatus for efficiently implementing a local or distributed file system. The invention may provide a distributed virtual file system that utilizes a persistent intent log for recording transactions to be applied to one or more local or other real underlying file systems.

### BACKGROUND OF THE INVENTION

Distributed file systems allow users to access and process data stored on a remote server as if the data were on their own computer. When a user accesses a file on the remote server, the server sends the user a copy of the file, which is cached on the user's computer while the data is being processed and is then returned to the server. Distributed file systems typically use file or database replication (distributing copies of data on multiple servers) to protect against data access failures. Examples of distributed file systems are described in the following U.S. patent applications Ser. No. 09/709,187, entitled “Scalable Storage System”; Ser. No. 09/659,107, entitled “Storage System Having Partitioned Migratable Metadata”; Ser. No. 09/664,667, entitled “File Storage System Having Separation of Components”; and Ser. No. 09/731,418, entitled, “Symmetric Shared File Storage System,” all of which are assigned to the present assignee and are incorporated herein by reference. These applications are hereinafter collectively referred to as the “prior Agami applications”.

Another type of distributed file system is known as the Andrew file system or AFS. AFS supports making a local replica of a file at a given machine, as a cached copy of the master file, and later copying back any updates. AFS, however, does not provide any mechanism that allows both copies to be concurrently writeable. AFS also requires all updates to be written through the local file system for reliability.

Another prior art distributed file system is discussed in U.S. Pat. No. 6,564,252 of Hickman (“Hickman”). Hickman describes a scalable storage system, with multiple front-end web servers, and accessed partitioned user data in multiple back-end storage servers. Data, however, is partitioned by user, so the system is not scalable for a single intensive user, or for multiple users sharing a very large data file. That is, unlike the systems described in the prior Agami applications, Hickman is only scalable for extremely parallel workloads. This is reasonable in the field of application Hickman describes, web serving, but not for more general storage service environments. Hickman also sends all writes through a single, non-scalable “write master”, so writes are not scalable, unlike the earlier and current applications. While Hickman describes the notion of a journal of writes, which may be used to recover a failed storage server, Hickman only uses the journal for recovery, and does not address using the journal to improve performance. Hickman further does not anticipate bi-directional resynchronization, where updates proceed in parallel and two concurrently written journals are reconciled during recovery.

It would therefore be desirable to provide an improved method and apparatus for implementing a distributed file system.

### SUMMARY OF THE INVENTION

The present invention provides a method and apparatus for efficiently implementing a local or distributed file system. In one embodiment, the system and method provide a distributed virtual file system (“dVFS”) that utilizes a persistent intent log (“PIL”) to record transactions to be applied to the file system. The PIL is preferably implemented in stable storage, so that a logical operation may be considered complete as soon as the log record has been made stable. This allows the dVFS to continue immediately, without waiting for the operation to be applied to a local or other real underlying file system. The dVFS may further incorporate replication to one or more remote file systems as an integral facility. The system and method of the present invention may be used within a heterogeneous collection of one or more computer systems, possibly running different operating systems, and with different underlying disk-level file systems.

According to one aspect of the present invention, a file system is provided. The file system includes one or more front-end elements that provide access to the file system; one or more back-end elements that communicate with the one or more front-end elements and provide persistent storage of data; and a persistent log that stores file system operations communicated from the one or more front-end elements to the one or more back-end elements. The file system treats the file system operations as complete when the operations are stored in the log, thereby allowing the file system to continue operating without waiting for the operations to be applied to the one or more back-end elements.

According to another aspect of the invention, an apparatus is provided for implementing a file system including a plurality of front-end elements that provide access to the file system and one or more back-end elements that communicate with the front-end elements and provide persistent storage of data. The apparatus includes a persistent log that stores file system operations communicated from the one or more front-end elements to the one or more back-end elements; and a process that allows the file system to continue operating once the operations are stored in the log without waiting for the operations to be applied to the one or more back-end elements.

According to another aspect of the invention, a method is provided for implementing a file system having one or more front-end elements that provide access to the file system, and one or more back-end elements that communicate with the one or more front-end elements and provide persistent storage of data. The method includes: storing operations in a persistent log, wherein the operations comprise file system operations communicated from the one or more front-end elements to the one or more back-end elements; and allowing the file system to continue operating once the operations are stored in the log without waiting for the operations to be applied to the one or more back-end elements.

These and other features and advantages of the invention will become apparent by reference to the following specification and by reference to the following drawings.

### BRIEF DESCRIPTION OF THE DRAWINGS

FIG. 1 is a block diagram of a storage system incorporating a distributed virtual file system, according to the present invention.

FIG. 2 is an exemplary block diagram illustrating the communication of file system operations between front-end and back-end elements, according to the present invention.

FIG. 3 is an exemplary block diagram illustrating file system replication, according to the present invention.

### DETAILED DESCRIPTION OF THE EMBODIMENTS

The present invention will now be described in detail with reference to the drawings, which are provided as illustrative examples of the invention so as to enable those skilled in the art to practice the invention. The present invention may be implemented using software, hardware, and/or firmware or any combination thereof, as would be apparent to those of ordinary skill in the art. The preferred embodiment of the present invention will be described herein with reference to an exemplary implementation of a storage system including a distributed virtual file system. However, the present invention is not limited to this exemplary implementation, but can be practiced in any storage system.

I. General Description of the Distributed Virtual File System

The present invention provides a virtual file system, which stores its information in one or more disk-level real file systems, residing on one or more computer systems. This distributed Virtual File System (“dVFS”) provides very low latency for updates, by use of a Persistent Intent Log (“PIL”), which is ahead of the real file system or file systems. The PIL records a record for each logical transaction to be applied to the real file system or file systems (e.g., a local file system (“LFS”)). That is, for each file system operation that modifies a file system or LFS, such as “create a file”, “write a disk block”, or “rename a file”, the dVFS writes a transaction record in the PIL. The PIL is preferably implemented in stable storage, so that the logical operation can be considered complete as soon as the log record has been made stable, thus allowing the application to continue immediately, without waiting for the operation to be applied to the LFS, while still assuring that all updates are preserved. In one embodiment, the stable storage used for the PIL may include battery-backed main or auxiliary memory, flash disk, or other low-latency storage which retains its state across power failures, system resets, and software restarts. If, however, preservation of data across power failures, system resets, and software restarts is not required for a given file system, as for a temporary file system, ordinary main memory may be used for the PIL. The system and method of the present invention may be used within a heterogeneous collection of one or more computer systems, possibly running different operating systems, and with different underlying disk-level file systems.

When the dVFS is implemented on top of multiple LFS instances, on multiple computer systems, the PIL may be stored in part on each of the computer systems. A given record is recorded in the portion of the PIL residing on each of the computer systems to which a given operation applies. For a write to a single LFS in a non-fault tolerant configuration, the record will be recorded only at that LFS. For operations that span LFS instances, such as a rename from a directory in one LFS to a directory in another LFS on a different computer system, the record will be recorded in each location to which it applies. For fault-tolerant configurations, where a given data item is recorded in two LFS instances on different computer systems, even a write operation record will be recorded on multiple PIL sections, one on each system to which the write applies.

Since the operations recorded in the PIL are stable from the point of view of the users of the file system as soon as the operations have been recorded, applying the operations to the underlying LFS can been done over time, in an order which is not necessarily the same as the order in which the operations were added to the PIL, as long as logically dependent operations are performed in order (such as creating a file before writing to it). This allows the operations to be sorted in ways which maximize the performance of the disks on which the LFS is stored, by doing more logical operations for each disk seek (e.g., through clustering of operations on files which are located near each other on the disk), and by taking advantage of the write buffers on modem disks to allow rotational position optimization, without compromising reliability.

The dVFS may also exhibit replication. The term “replication” in the context of this invention should be understood to mean making copies of a file or set of files or an entire dVFS on another dVFS or on multiple other dVFS instances. In other contexts, replication may sometimes be used to include “block level” replication, where block writes to a disk volume are replicated to some other volume. However, in the present invention, replication means replication of logical files or sets of files, not the physical blocks representing the file system.

In one embodiment, replication is implemented by transmitting a copy of each of the relevant records in the PIL to the remote system or systems where the replicas of the selected files are to be maintained. Since only records related to files selected for replication need be to copied, the bandwidth required is roughly proportional to the volume of updates to those files, not proportional to the total volume of updates to the source file system.

Further, if asynchronous replication is selected, it is possible to elide compensating operations, such as the creation, writing, and deletion of a file, so that those operations are never transferred at all, if all are in the buffer of operations awaiting transmission at the same time. Eliding compensating operations may be accomplished by maintaining an ordered list of operations pending in the log against a given file, and, if a delete operation is added, and the first operation in the list is “create”, discarding the entire list of operations. (If the first operation is not “create”, then all operations but the delete may be discarded.)

The log-based replication model has the further benefit of allowing an online and consistent view of the replica, whether replication is synchronous or asynchronous. Unlike block-based replication schemes, which do not permit the remote file system to be mounted while replication is in progress, the log-based model allows live use of the replica. This is possible because the log-based replication logically applies operations at the replica in order, although, since the operations are stored in PIL elements at the replica, the operations may be applied to the underlying disk-level file systems out of order.

Lastly, with the addition of a distributed lock manager, the log-based replication scheme, since it maintains a consistent view at the replica, can support exchanging source and destination roles, thus allowing local control and real time access to a collection of files to migrate geographically, to minimize overall access latency for collections of replica sites separated by long distances and hence long speed-of-light delays.

II. General System Architecture

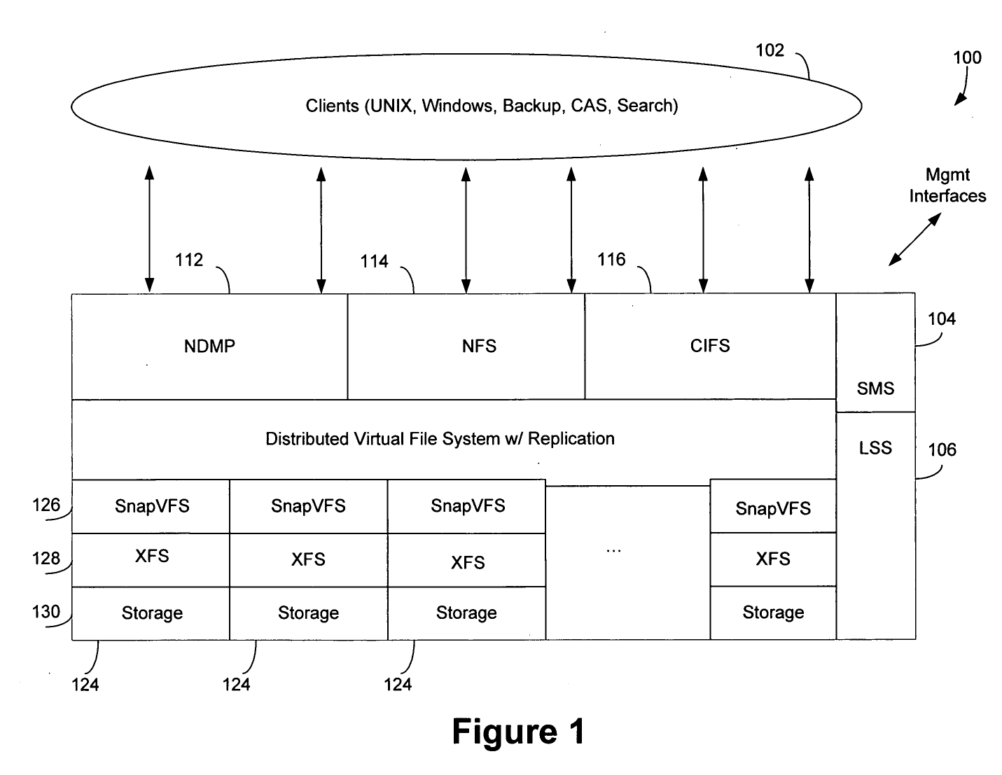

FIG. 1 illustrates one exemplary embodiment of a storage system 100 incorporating a dVFS 110, according to the present invention such as the dVFS described in Section I. The storage system 100 may be communicatively coupled to and service a plurality of remote clients 102. The system 100 has a plurality of resources, including one or more Systems Management Servers (SMS) processes 104 and Life Support Services (LSS) processes 106. The system 100 may implement various applications for communicating with clients through protocols such as Network Data Management Protocol (NDMP) 112, Network File System (NFS) 114, and Common Internet File System (CIFS) protocol 116. The system 100 may also include a plurality of local file systems 124 that communicate with the dVFS 110, each including a SnapVFS 126, a journalled file system (XFS) 128 and a storage unit 130.

The SMS process 104 may comprise a conventional server, computing system or a combination of such devices. Each SMS server may include a configuration database (CDB), which stores state and configuration information relating to the system 100. The SMS servers may include hardware, software and/or firmware that is adapted to perform various system management services. For example, the SMS servers may be substantially similar in structure and function to the SMS servers described in U.S. Pat. No. 6,701,907 (the “'907 patent”), which is assigned to the present assignee and which is fully and completely incorporated herein by reference.

In one embodiment, the Life Support Services (LSS) process 106 may provide two services to its clients. The LSS process may provide an update service, which enables its clients to record and retrieve table entries in a relational table. It may also provide a “heartbeat” service, which determines whether a given path from a node into the network fabric is valid. The LSS process is a real-time service with operations that are predictable and occur in a bounded time, such as within predetermined periods of time or “heartbeat intervals.” The LSS process may be substantially similar to the LSS process described in the '907 patent.

In the embodiment of FIG. 1, the client communication applications may include NDMP 112, CIFS 116 and NFS 114. NDMP 112 may be used to control data backup and recovery communications between primary and secondary storage devices. CIFS 116 and NFS 114 may be used to allow users to view and optionally store and update files on remote computers as though they were present on the user's computer. In other embodiments, the system 100 may include applications providing for additional and/or different communication protocols.

The SNAP VFS 126 is a feature that provides snapshots of a file system at the logical file level. A snapshot is a point-in-time view of the file system. It may be implemented by copying any data modified after the snapshot is taken, so that both the data as of the snapshot and the current data are stored. Some prior art systems provide snapshots at the volume level (below the file system). However, these “prior art” snapshots do not have the efficiency and flexibility of file-level snapshots, which only duplicate logical data, not every physical block, especially overhead blocks, such as disk allocation maps, modified by a file update. In one embodiment, XFS 128 is the XFS file system created by SGI, originally implemented in SGI IRIX and since ported to Linux. In one embodiment, the XFS 128 has journalled metadata, but not journalled file data. Storage resources 130 are conventional storage devices that provide physical storage for XFS 128.

III Operation of the DVFS and PIL

A. Overall Operation

In the dVFS 110, there are in general multiple “front-end” processing elements that provide file access to local applications and to network file access protocol service instances. (These may also be termed “gateways”.) The “front-end” elements are the upper level of dVFS 110, e.g., one instance per file system per hardware module providing access to the file system. Each front-end may represent the given virtual file system instance on that module, and distribute operations as appropriate to “back-end” elements on the same or other modules and to remote systems (for replication). The “back-end” elements are the lower level of the dVFS 110, e.g., one instance per file system per hardware module storing data for that file system. Each back-end element controls whatever disk storage is assigned to the file system on its module, and is responsible for providing persistent (stable) storage of data.

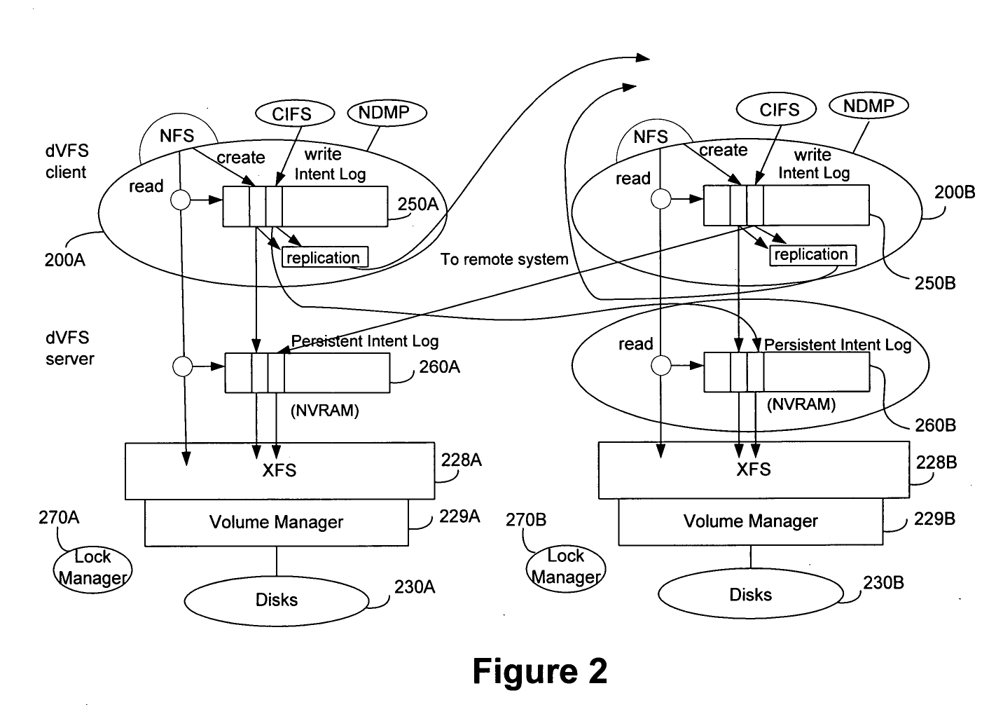

FIG. 2 illustrates an example of the communication of data and file system operations between front-end and back-end elements, according to the present invention. Each “front-end” element 200A,B constructs its stream of records destined for the PIL 260A,B in a local intent log 250A,B. This local log is a buffer for updates being sent to the PIL 260A,B and to replica sites, so entries are not considered persistent (and hence are not acknowledged to the network file access client or local application as complete) until they have been transmitted to one or more PIL locations, local or remote, with the number required being determined by the reliability policy for the file system. (Data reliability increases as the number of copies increases, since the chance of simultaneous failure of all of the copies is much less than the chance of failure of just one copy.)

In dVFS 110, persistent storage is in back-end elements of the overall system of multiple machines. In dVFS 110, a given back-end element typically holds both file metadata and some file data, typically all of the file data for a given file if the metadata for that file is on the element and the file is small. For large files, segments of the file are stored as LFS file objects on other back-end elements as well, for scalability. In the terms used in the prior Agami applications, a dVFS back-end may combine “metadata server” and “storage server” functionality in one element, but storage segments for larger files may still in general be distributed over multiple back-end elements. Also, metadata may be distributed over multiple back-end elements, just as it was distributed over multiple “metadata server” elements in the prior Agami applications. In FIG. 2, the back-end elements illustrated may include XFS 228A,B, volume managers 229A,B and storage devices or disks 230A,B.

When the dVFS front-end element 200A,B receives a given logical request, it enters an operation record in the local intent log 250A,B, and then waits until that record has been sufficiently distributed to PIL segments 260A,B in the back-end elements. The system may include a set of “drainer” threads or state machines that stream local intent log records to their destinations. A separate set of “acknowledgement” threads or state machines handle acknowledgements from the destinations for records, and post completion (persistence) of those records to any waiting logical requests.

Since the PIL is persistent, the drainer threads may apply operations out of order, as long as they are logically independent. For example, two writes to different blocks, may be applied out of order, and two files created with different names may be created out of order. Further, complementary operations may be elided. For instance, a file create, followed by some writes to the file, followed by the delete of the file, may be discarded as a unit. Since the front-end verifies that every operation must succeed before entering it in the PIL in this embodiment, no later operation can possibly fail if the set of complementary operations is discarded. Note that the verification that the operation must succeed may include reserving sufficient space for the operation in the underlying file system or file systems. This approach substantially improves the update efficiency of the LFS, both by reducing the total number of operations and by clustering related operations.

B. Consistency

The destinations for a given record will include one or more local PIL segments and may include one or more remote replica systems. Since there are multiple front-end elements generating records in parallel, and transmitting them to back-end elements and to replica systems in parallel, performance is scalable with the number of elements. There are, however, some issues of consistency that are addressed by the system. First, it would in general be possible for two front-end elements (e.g., 200A and 200B) to initiate a write to the same location in the same file at the same time. If the file were being stored on two back-end elements for purposes of redundancy, it would be possible, absent some solution for maintaining distributed consistency, for one back-end to apply the updates in one order and the other back-end to apply the updates in the reverse order, depending on the vagaries of communication delays.

In one embodiment, the system provides two solutions to this problem, and may choose a particular solution depending on the circumstances. In the typical case, where there is little contention, a lock manager 270A,B can be used to allow only one machine to make updates to a given file or part of a file at a time. In one embodiment, lock manager 270A,B may be distributed over each of the back-end elements. The dVFS front-end elements address their requests for locks on a given object to the lock manager instance on the back-end element that stores that object. For duplicated objects (as when the data for a file is stored on two back-end elements for redundancy), the two lock managers (e.g., lock managers 270A,B) negotiate which is to be the primary lock manager. (A simple rule is that, if one is currently the primary, it remains so; if neither is currently the primary, the one with the lower-numbered module identifier or address becomes primary.) The primary publishes its identity as such in LSS, and the backup redirects front-ends to the primary if it receives requests that should have gone to the primary, as a consequence of LSS update delays. Note that the lock manager for a portion of the data for a file may be different from the lock manager for the metadata for the file, if the data for the file is spread across multiple back-end elements. That is, if the data is partitioned, the lock manager for each partition is co-resident with the partition.) The holder of an update lock is required to flush any pending writes protected by the lock to all relevant back-end elements, including receiving acknowledgements, before relinquishing the lock, so requests seen at the various back-end elements will be properly serialized, at the cost of a lower level of concurrency.

A second solution may be used if the lock manager detects a high level of lock ownership transitions for a given file or part of a file. In that case, the lock manager may grant a “shared write” lock instead of an exclusive lock. The shared write lock requires that each front-end not cache copies of data protected by the lock for later reading, and to flag all operations protected by the lock as such. A back-end element receiving an operation so flagged, and which is specified as being delivered to two or more back-end elements, must hold the operation in its PIL and neither apply it nor respond to reads which would be affected by it until it has: (1) exchanged ordering information with the other element or elements to which that operation was delivered, and (2) agreed on a consistent order. Since the operation is safe in the PIL, clients can proceed, so parallel writes of large files can be very fast. The buffering implicit in the PIL allows the latency of determining a serial order for requests to be masked, and also allows that determination to be done for a batch of requests at a time, thereby reducing the overhead.

In one embodiment, the algorithm implemented by the system for determining a serial order accounts for cases where some of the back-end elements have not received (and may never receive, in the event of a front-end failure) certain operations. This may be handled by exchanging lists of known requests, and having each back-end element ship to its peer any operations that the peer is missing. Once all back-end elements have a consistent set of operations, they resume normal operation, which includes periodic exchange of ordering information (specifying the serial order of conflicting writes). A simple means of arriving at a consistent order is for the back-end elements handling a given replicated data set to elect a leader (as by selecting that element with the lowest identifier) and to rely on the leader to distribute its own order for operations as the order for the group. This requirement for determining the serial order of operations is applicable only when “shared write” mode has been used. To make recovery simple, writes done in “shared write” mode should be so labeled, so that the communication to determine serial order is only done when such writes are outstanding.

C. Coherency

Since operations may be buffered in the PIL for some time, a front-end element could ask a back-end element for a data block or file object for which an update is buffered in the PIL. If the request for the data item were to bypass the PIL and fetch the requested item from the underlying file system, the request would see old data, not reflecting the most recent update. The PIL, therefore, maintains an index in memory of pending operations, organized by file, type of information (metadata, directory entry, or file data), and offset and length (for file data). Each request checks the index and merges any pending updates with what it finds in the underlying file system. In some cases, where the request can be satisfied entirely from the PIL, no reference to the underlying file system is made, which improves efficiency.

In one embodiment, the PIL index is not persistent. On recovery from a failure, such as a power failure, the PIL recovery logic reconstructs the index from the contents of the PIL.

In the case of “shared write” mode, with parallel writes to two or more back-end elements, a read from one back-end element might see a different result than a read from the other back-end element, if no coordination were applied. Thus, the system may use the following coordination. If a given back-end element receives a read, and finds a match in its index, and if that match is for a write for which the serial order has not been determined, then the read is blocked until the serial order is determined. Note that this case does not apply to normal exclusive write mode, since in that case the front-end holding the exclusive write lock determines and specifies the serial order for writes.

D. Migration

As discussed in the prior Agami applications, true scalability in a distributed storage system is made possible by the ability to migrate file objects from one back-end element to another. Unlike various examples in other prior art systems, the migration described in the prior Agami applications is not based on migrating entire partitions, or on modifying a global partitioning predicate. Instead, a region of the file directory tree (possibly as small as a single file, but typically much larger) is migrated, with a forwarding link left behind to indicate the new location. Front-end elements cache the location of objects, and default to looking up an object in the partition in which its parent resides.

In one embodiment, the dVFS 110 supports this approach to migration by introducing the notion of an “External File IDentifier” (EFID), and a mapping from EFID to the “Internal File IDentifier” (IFID) used by the underlying file system as a handle for the object. The mapping includes a handle for the particular back-end partition in which the given IFID resides. The EFID table is partitioned in the same way as the files to which the EFIDs refer. That is, one looks up the EFID to IFID mapping for a given EFID in the partition in which one finds a directory entry referencing that EFID. There is a global table of partitions, giving the partition holding a given range of EFIDs. Each front-end element caches a copy of this global table, so that it can quickly locate an object by EFID when required (as when presented with an NFS file handle containing an EFID for which the referenced object is not in its local cache).

The PIL records the EFID to which each operation applies along with, if known the IFID. The EFID is always known, for each object creation, since it is assigned by the front-end, from a set of previously unassigned EFIDs reserved by the front-end. (Each back-end is assigned primary ownership of a range of EFIDs, which it can then allow front-ends to reserve. As the EFIDs are consumed, the SMS element assigns additional ranges of EFIDs to the back-ends, which are running low on them. The EFID range is made large enough (64 bits) that there is not practical danger of using all EFIDs.) When an object is created in the LFS, the IFID is returned by the local file system, and the PIL records the IFID and then applies an update to the EFID-to-IFID mapping table, before marking the operation complete. A migration operation records the creation of a new copy of an object in the destination back-end PIL, and then enters a record for the deletion of the old copy of the object in the source back-end PIL, together with an update to the EFID-to-IFID map in both back-ends.

E. Resource Management

In one embodiment of dVFS 110, the dVFS ensures that operations complete once entered in the operation log (e.g., intent log 250A,B). Thus, a front-end element ensures that there will be sufficient resources in each back-end element, which must take part in completing an operation, before entering the operation in the log. The front-end element may do this by reserving resources ahead of time, and reducing its reservation by the maximum resources expected to be required by the operation.

A given front-end element may maintain reservations of resources (mainly PIL space and LFS space) on each back-end element to which it is sending operations. If it has no use for a reservation it holds, it releases it. If it uses up a reservation, it may obtain an additional reservation. If a front-end element fails, its reservations are released, so a restarted or newly started front-end element will obtain new reservations before committing an operation. When the front-end element delivers an operation to the front-end operations log, it decrements the resources it has reserved for each of the back-end elements to which the operation is destined. For example, if a write will be applied to two different back-end elements, as on a distributed mirrored (RAID-1) write, it will require space on each of the two back-end elements.

In one embodiment, the front-end element decrements its reserved space by the worst case requirement for a given back-end. When the operation is actually recorded in the PIL, the actual space will be used up, and the space available for new reservations will decrease by that amount. Thus, if the front-end element estimates that two pages will be required, and only one is used, then one page will still be available for future reservations, even though the front-end decremented its reserved space by two pages.

Care may be taken in the back-end elements to avoid having the worst case reservation be large. For example, if writing one page to a file would require one page of space in the normal case, but 10 pages in some allocation scenario, the front-end would have to assume 10 pages, which would artificially reduce the useful size of the PIL. Hence, the back-end elements will contrive to always be able to retire operations recorded in the PIL with bounded space. Once the actual usage is known, excess reserved resources will be released by the back-end, becoming available for future reservations.

F. Synchronization of Lower-level Buffers

In one embodiment, buffering in memory of some operations may occur at the logical file system level, at the disk volume level, and/or at the disk drive level. This means that applying an operation to the logical file system in the drainer does not mean that the operation may be considered completed and eligible for removal from the PIL. Instead, it will be considered tentative, until a subsequent checkpoint of the underlying logical file system has been completed. (The term “checkpoint” here is used in the sense of a database checkpoint: buffered updates corresponding to a section of the journal are guaranteed to be flushed to the underlying permanent storage, before that section of journal is discarded.)

The PIL may maintain a checkpoint generation for each operation, which is set when the operation is drained. The PIL drainers periodically ask the underlying logical file system to perform a checkpoint, after first incrementing the checkpoint generation number. After the checkpoint is completed, the drainers discard all operations with the prior generation number, which are now safe on permanent storage. (This is a technique used in conventional database systems and journalled file systems.)

G. Recovery

1. Local Recovery

If a machine fails, whether due to power failure, system reset, or software failure and restart, the contents of the dVFS may be recovered to a consistent state by use of the PIL (assuming that the PIL remains substantially unharmed). Since the PIL is in non-volatile storage, the ability for recovery in such a situation is reasonably likely. Further, in a clustered environment, a given PIL may be mirrored to a second hardware module, so that it is unlikely that both copies will fail at once. (If the local copy is lost, the first step is to restore it from the remote copy, in the remote mirroring case.)

PIL recovery proceeds by first identifying the operations log. This may be performed using conventional techniques typically used for database or journalled file system logs. For example, the system may scan for log blocks in the log area, having always written each log block with header and trailer records incorporating a checksum, to allow incomplete blocks to be discarded, and a sequence number, to determine the order of log blocks. The log records are scanned to identify any data pages separately stored in the non-volatile storage, and any pages not otherwise identified are marked free.

The next step is to reconstruct the coherency index (e.g., discussed in Section III.C.) to the PIL in main memory, to allow resumption of reads. Lastly, for each record, the underlying logical file system (the disk-level file system) is inspected to determine whether the particular operation was in fact performed, if the operation is not idempotent. For operations such as “set attributes” or “write”, this check is not required: such operations are simply repeated. For operations such as “create” and “rename”, however, the system avoids duplication. To do so, the system scans the log in order. If the system determines an operation to be dependent on an earlier operation known to have not been completed, then the system marks the new operation as not completed.

Otherwise, for “create”, the system may first try to look up the object by EFID. If the lookup succeeds, then the create succeeded, even if the object was subsequently renamed, so the system marks the “create” as done. If the lookup by EFID fails, then one looks up the object by name and verifies that the EFID matches. If it does not, and there is no operation in the PIL for the EFID of the object found, then the create did not happen, since the object found must have been created before the new create. If the EFID does match, then entering the EFID did not complete, so the system marks the operation as partially complete, with the EFID update still required.

For “rename”, the system may first check if the EFID-to-IFID mapping exists. If not, the rename must have completed and been followed by a delete, since rename does not destroy the mapping and cannot complete until the mapping is created. Otherwise, the system may split the operation into creating the new name and deleting the old name. If the new name exists, but is for a different IFID, the system unlinks the new name (if its link count is greater than 1) or renames it to an orphan directory (if its link count is 1) and creates the new name as a link to the specified object. Then the system removes the old name, if it is a link to the specified object. At the end of recovery, the system removes all names from the orphan directory.

For “delete”, the system may proceed as for “rename”, removing the specified name if the IFID matches, but renaming it to the orphan directory if the link count is one.

Once the state of all operations has been determined, normal operation resumes.

2. Distributed Recovery

When multiple back-end elements participate in a given dVFS instance, recovery will reconcile operations which apply to more than one back-end element. Since the dVFS considers an operation persistent as soon as the complete operation is stored on at least one back-end element, each back-end element must assure that other “back-ends” affected by one of its operations have a copy of the operation. After first recovering its local log, each back-end handles this by sending to each other back-end a list of operation identifiers (composed of a front-end identifier and a sequence number set by the front-end) for which it is doing recovery which also apply to that other back-end. The other back-end then asks for the contents of any operations that it does not have and adds them to its log. At this point, each log has a complete set of relevant operations. (Missing operations are of course marked “not completed” when delivered.)

The next step is to resolve the serial order for any operations for which that is not known (mainly parallel writes originated under “shared write” coherency mode). After that step, handled as in normal operation, as noted above, each back-end is free to resume normal operation.

H. Replication

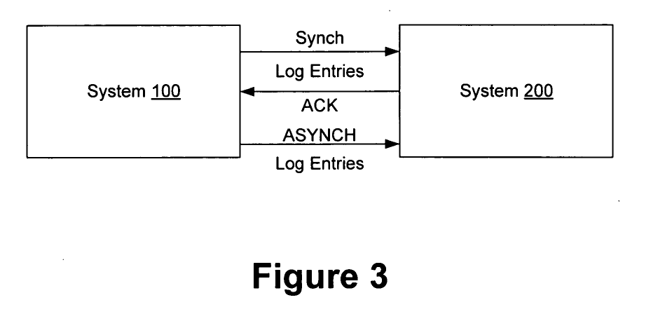

Since dVFS 110 can support applying the same operation in multiple places, file system replication may be an inherent part of dVFS operation. FIG. 3 shows one example of how file system replication may occur in the present system. By transmitting the stream of operation log entries from system 100 to a remote system 200, and applying them there, the remote system 200 will be a consistent copy of the local system 100. The system may employ either synchronous or asynchronous replication. If the system waits for an operation to be acknowledged as persistent by the remote system 200 before considering the operation complete, then the replication is synchronous. If the system does not wait, then the replication is asynchronous. In the latter case, the remote site 200 will still be consistent, but will reflect a point some small amount of time in the past.

A key observation is that this approach to replication minimizes the amount of information sent to the remote system 200. This reduces latency (due to bandwidth limitations) and hence increases performance, compared to replication at the volume level (below the logical file system), where entire logical file system metadata blocks must in general be copied, not just the few bytes for a file name or file attributes.

Further, since the operations can be logically segregated into independent sets of operations, if the operations do not conflict, one can have one set of files replicated from site A to site B and a second set of files replicated from site B to site A, in the same file system, as long as each site allocates new EFIDs from disjoint pools at a given point in time. This in turn allows the primary locus of control of a given set of files to migrate from site A to site B, via a simple exchange of ownership request and grant operations embedded in the operations log streams. Since the operations logs serialize all operations, such migration works even with asynchronous replication, as is typically required when the sites involved are separated by long distances and the latency due to the speed of light is large.

Note that the replication may be one to many, many to one, or many to many. The cases are distinguished only by the number of separate destinations for a given stream of requests.

Recovery proceeds exactly as in the local case of multiple back-end instances, except that the “source” site for a given set of files may proceed with normal operation even if the “replica” site is not available. In that case, when the replica site does become available, missing operations are shipped to the replica and then normal operation resumes. If the replica has lost too much state, then recovery proceeds as in the distributed RAID case described in prior Agami applications (copying all files, while shipping new operations, and applying new operations to any files already shipped, until all files have been shipped and all operations are being applied at the replica). Excessive loss of state is detected when the newest entry in the PIL of the replica is older than the older entry in the PIL of the source. Excessive loss of state may be delayed at the source by buffering older PIL entries on disk, so that they may later be read back as part of recovery of the replica.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims include such changes and modifications. It should be further apparent to those skilled in the art that the various embodiments are not necessarily exclusive, but that features of some embodiments may be combined with features of other embodiments while remaining with the spirit and scope of the invention.

1. A file system comprising:
one or more front-end elements that provide access to the file system;
one or more back-end elements that communicate with the one or more front-end elements and provide persistent storage of data; and
a persistent log that stores file system operations communicated from the one or more front-end elements to the one or more back-end elements;
wherein the file system treats the file system operations as complete when the operations are stored in the log, thereby allowing the file system to continue operating without waiting for the operations to be applied to the one or more local file systems.

2. The file system of claim 1 wherein the file system is distributed over a plurality of computer systems.

3. The file system of claim 2 wherein the persistent log is stored in part on each of the plurality of computer systems.

4. The file system of claim 1 wherein the persistent log is implemented using stable storage.

5. The file system of claim 4 wherein the stable storage comprises battery-backed memory, flash memory, or a low-latency storage device.

6. The file system of claim 1 wherein the one or more front-end elements comprise a second log that buffers updates to be sent to the persistent log.

7. The file system of claim 6 wherein the one or more front-end elements confirm that there are sufficient resources for an operation to be performed on corresponding back-end elements before placing the operation in the second log.

8. The file system of claim 1 wherein the file system can apply operations from the persistent log to the back-end elements out of order.

9. The file system of claim 1 further comprising a lock manager that maintains data consistency in the file system.

10. The file system of claim 9 wherein the lock manager provides an exclusive lock that allows only a certain element to update files at a given time.

11. The file system of claim 9 wherein the lock manager provides a shared write lock function.

12. The file system of claim 1 wherein the persistent log maintains an index of pending operations, and wherein the one or more front-end elements check the index when receiving a request for data to ensure data coherency.

13. The file system of claim 12 wherein the one or more front-end elements satisfy a request for data using the persistent log whenever possible.

14. The file system of claim 1 wherein objects can be migrated from one back-end element to another.

15. The file system of claim 1 wherein the file system is adapted to provide for replication by transmitting entries from the persistent log to a second file system.

16. The file system of claim 15 wherein the replication is synchronous.

17. The file system of claim 15 wherein the replication is asynchronous.

18. An apparatus for implementing a file system including a plurality of front-end elements that provide access to the file system and one or more back-end elements that communicate with the front-end elements and provide persistent storage of data, the apparatus comprising:
a persistent log that stores file system operations communicated from the one or more front-end elements to the one or more back-end elements; and
a process that allows the file system to continue operating once the operations are stored in the log without waiting for the operations to be applied to the one or more back-end elements.

19. The apparatus of claim 18 wherein the persistent log is stored in part on each of a plurality of computer systems.

20. The apparatus of claim 18 wherein the persistent log is implemented using stable storage.

21. The apparatus of claim 20 wherein the stable storage comprises battery-backed memory, flash memory, or a low-latency storage device.

22. The apparatus of claim 18 further comprising:
a second log that buffers updates to be sent to the persistent log.

23. The apparatus of claim 22 wherein the second log is located in the one or more front-end elements.

24. The apparatus of claim 23 further comprising:
a second process that confirms that there are sufficient resources for an operation to be performed on corresponding back-end elements before placing the operation in the second log.

25. The apparatus of claim 18 wherein the process selectively applies operations from the persistent log to the back-end elements out of order.

26. The apparatus of claim 18 further comprising:
a lock manager that maintains data consistency in the file system.

27. The apparatus of claim 26 wherein the lock manager provides an exclusive lock that allows only a certain element to update files at a given time.

28. The apparatus of claim 26 wherein the lock manager provides a shared write lock function.

29. The apparatus of claim 18 further comprising:
a replication process for replicating the file system by transmitting entries from the persistent log to a second file system.

30. A method for implementing a file system having one or more front-end elements that provide access to the file system, and one or more back-end elements that communicate with the one or more front-end elements and provide persistent storage of data, the method comprising:
storing operations in a persistent log, wherein the operations comprise file system operations communicated from the one or more front-end elements to the one or more back-end elements; and
allowing the file system to continue operating once the operations are stored in the log without waiting for the operations to be applied to the one or more back-end elements.

31. The method of claim 30 wherein the file system is distributed over a plurality of computer systems.

32. The method of claim 31 wherein the log is stored in part on each of the plurality of computer systems.

33. The method of claim 30 wherein the persistent log is implemented using stable storage.

34. The method of claim 33 wherein the stable storage comprises battery-backed memory, flash memory, or a low-latency storage device.

35. The method of claim 30 further comprising:
buffering updates to be sent to the persistent log in a second log contained in the one or more front-end elements.

36. The method of claim 30 further comprising:
applying operations from the persistent log to the back-end elements out of order.

37. The method of claim 30 further comprising:
maintaining data consistency in the file system using a lock manager.

38. The method of claim 37 wherein the lock manager provides an exclusive lock that allows only a certain element to update files at a given time.

39. The method of claim 37 wherein the lock manager provides a shared write lock function.

40. The method of claim 30 further comprising:
maintaining an index of pending operations in the persistent log; and
checking the index before requesting data from the one or more back-end elements to ensure data coherency.

41. The method of claim 40 further comprising:
satisfying a request for data using just the persistent log.

42. The method of claim 40 further comprising:
migrating objects from one back-end element to another.

43. The method of claim 35 further comprising:
confirming that there are sufficient resources for an operation to be performed on corresponding back-end elements before placing the operation in the second log.

44. The method of claim 30 further comprising:
replicating the first file system by transmitting entries from the persistent log to a second file system.

45. The method of claim 44 wherein the replicating is synchronous.

46. The method of claim 44 wherein the replicating is asynchronous.

47. The method of claim 44 further comprising:
reviewing entries from the persistent log for compensating operations prior to transmitting the entries to the second file system; and
eliding compensating operations.
